(19) United States
(12) Patent Application Publication
(10) Pub. No.: US 2007/0043545 A1
(43) Pub. Date: Feb. 22, 2007

(54) Molecular simulation method and device

(75) Inventors: Yasushige Yonezawa, Suita-shi (JP); Toshikazu Takada, Minato-ku (JP); Kazuto Nakata, Minato-ku (JP); Toshihiro Sakuma, Minato-ku (JP); Haruki Nakamura, Suita-shi (JP)

Correspondence Address: DICKSTEIN SHAPIRO LLP, 1177 AVENUE OF THE AMERICAS (6TH AVENUE), NEW YORK, NY, 10036-2714, US

(73) Assignees: NEC CORPORATION, Tokyo (JP); OSAKA UNIVERSITY, Osaka (JP)

(21) Appl. No.: 10/573,023

(22) PCT Filed: Sep. 22, 2004
(86) PCT No.: PCT/JP04/13808

§ 371 Date: Mar. 22, 2006

(30) Foreign Application Priority Data
Sep. 22, 2003 (JP) 2003-329751

(51) Int. Cl. G06G 7/48; G06G 7/58

(52) U.S. Cl. 703/11; 703/12

(57) ABSTRACT

A molecular simulation method for dividing a molecule or a part of molecule to be simulated into a QM space and an MM apace and applying an ab initio molecular orbital method to the QM space and a method based on an empirical potential to the MM space to perform molecular simulation includes the steps of: retrieving structure data on the molecule or part of molecule to be simulated from a storage unit, and dividing the structure data into the QM space and the MM space; and replacing a part of a total energy expression in the ab initio molecular orbital method concerning the QM space with an empirical potential.

### TECHNICAL FIELD

The present invention relates to a method and a device for performing molecular simulation by a quantum chemical technique, and more particularly relates to a molecular simulation method and a device by a QM/MM (Quantum Mechanics/Molecular Mechanics) method in which the ab initio molecular orbital method and the molecular mechanics method are combined as one theoretical system among theoretical techniques of the quantum chemistry.

### BACKGROUND ART

With the development of the quantum chemical theory and the advance of computer technology, it has been possible to simulate structures, physical properties of compound molecules, chemical bonds, molecular orbital and electron states in a molecule accurately by calculations. Among such techniques, the ab initio molecular orbital method which principally does not depend on empirical parameters has been demonstrated about the validity of the theoretical scheme based on a great many calculation examples over the past scores of years. In recent years, it is required to apply the ab initio molecular orbital method to biological molecule in terms of fundamental researches in drug discovery and functional foods. For example, it is extremely available to researches on effective medicine in specific diseases to discover a ligand sophisticatedly and selectively bound to an active site in a specific protein. Such a ligand functions as an inhibitor in the sense that the activity of the protein is inhibited. Then, screening is performed to research actual prospective compounds among a great many compounds to be ligand prospects. In this case, if the prospective compounds can be screened by computer simulation without initiating actual chemical reactions, it can be expected to reduce a time required for screening as a whole significantly, besides, it is possible to attain great advantages in that ligands for proteins difficult to be mass-synthesized can be researched and ligands of which no chemical synthesis example exists yet can be researched. Therefore, the ab initio molecular orbital method has been used for such molecular simulation by a computer.

However, in the ab initio molecular orbital method, caused by enormous computational effort required for all-electron calculation, sizes of molecules capable of being calculated are limited to middle even now. For example, as described above, the ab initio molecular orbital method for complexes of proteins and ligands provides important information to researches in pharmaceutical prospective compounds, however, a long time is required for calculation of the electron state for whole system of complexes though the latest supercomputer is used, and the long time is generally unacceptable in terms of time scale of study and development in corporations.

Generally, about the proteins, though there are a great many amino acid residues, sites bound to ligands or the like are limited. Therefore, it is considered that only the sites and the vicinity thereof are subjected to accurate simulation about electron states. Accordingly, in a chemical system including many molecules, the QM/MM method is proposed in which a molecule or a part of molecule is divided into a QM (Quantum Mechanics) space where a noted chemical phenomenon occurs and a secondary MM (Molecular Mechanics) space other than the QM space and in which the QM space is processed by a quantum mechanical scheme such as the ab initio molecular orbital method and the MM space is described as empirical potential such as molecular mechanics [1]. Advantages of this method are following:

(1) the noted chemical phenomenon in the QM space is described by a method based on the quantum mechanics, and therefore high reliability calculation results is expected; and

(2) the MM space occupying the most of the molecule system is described by the empirical potential with light computational load, is processed as classical mechanics, and therefore the computation time is shortened significantly. For several years, attentions are given to the QM/MM method as the technique satisfying a mutually contradictory demand for the molecular simulation, namely, the preservation of reliability on calculation results and reduction in computation time, among many proposed molecular simulation theories.

As described above, the QM/MM is characterized in the reduction in the computation time compared with the conventional all-electron calculation. When a computation time is estimated about a protein including 500 amino acid residues, 95% or more of the whole computation time is used for the calculation of the QM space. When the QM method is applied to the whole of 500 amino acid residues, the calculation must be carried out for approximately fifty thousands of atomic orbitals. The computation time increases and decreases in proportion to third power of the number of atomic orbitals. So, when the QM/MM method is applied and only the active site and the vicinity thereof are treated as the QM space, the number of atomic orbitals to be calculated is approximately five thousands and the computation time is reduced to one-thousandth. Particularly, in calculations for a stable structure of a complex including a protein and a base or for a reaction mechanism of a enzyme, such a calculation must be repeated, it is unrealistic to perform the meaningful molecular simulation by methods other than the QM/MM method.

FIG. 1 is a conceptual view showing division into the QM space and the MM space in a protein-ligand complex. As shown in FIG. 1, the vicinity of the active site where ligand 1 is bound to protein 2 is regarded as QM space 21 and the other is regarded as MM space 22.

However, in the QM/MM method, a problem remains in the description method of the interactions between atoms belonging to the QM space and atoms belonging to the MM space. When no covalent bond is directly formed between the atoms belonging to the QM space and the atoms belonging to the MM space mutually, their interactions are represented by Coulomb force or van der Waals force, thereby treating junction between the QM space and the MM space without principle difficulties. However, when the covalent bonds are formed, one atom belongs to the QM space and the other belongs to the MM space, and therefore a serious problem occurs. For example, when the vicinity of the active site of the protein is treated as the QM space, the QM-MM junction face crosses the principal chain of the protein, namely, the covalent bonds, and the so-called σ (sigma) bonds between adjacent atoms are cut artificially.

FIG. 2 is a view for explaining division into the QM space and the MM space and showing one example of peptide linkage in a protein. In FIG. 2, as indicated by a dashed line, the QM space and the MM space are separated at a position of C—N bond of the principal chain in the second amino acid residue counted from the N-terminal (left side in FIG. 2). In the space division characterized in the QM/MM method, the following theoretical problems are pointed:

(1) Since one electron involved in the covalent bond is belonged to an atom in the QM space, an unpaired electron generates artificially in the atom to make the atom a radical. As a result, the chemical property of the system is distorted remarkably and it is impossible to obtain a correct description of the wave function in the QM space.

(2) Since the atom belonging to the MM space is represented as a point mass having a charge, the QM space having a continuous electron distribution and the discontinuous MM space including point masses are interacted while one chemical bond is regarded as a boundary. Therefore, it is impossible to obtain a smooth and continuous potential function of the system. Accordingly, there is a risk that behavior of atoms in the vicinity of the boundary area between the QM space and the MM space is not described correctly.

For the former, the method of introducing a hydrogen-similar atom bound by the covalent bonds to the unpaired electron, named as the link atom method is traditionally used [2]. However, in the link atom method, since the hydrogen-similar atom which does not exist in the original system is introduced, there is a problem in that an additional energy term appears and the correction thereof is required. Also, there is a possibility in that the introduced hydrogen-similar atom in itself brings changes in the property of the wave function. Recently, it is contrived that the atom belonging to the MM space is replaced with the hydrogen-similar atom, however, this contrivance does not solve the problem in the latter.

Further, there is proposed a method in that a localized orbital named as Bond Orbital is applied to the covalent bonds and an unpaired electron is prevented from generating [3]. However, since the orbital fixed in the axial direction of the chemical bond is used, corrections such as rotation of orbits together with movement of nuclei are required. Therefore, there is a difficulty in that the theory is complicated.

The problem in that the potential in the vicinity of the junction portion between the QM space and the MM space is not continuous is remarkable when the calculation of structure optimization or the time evolution calculation by the molecular dynamics method is performed. In other words, there is a possibility in that neighbor nuclei are remarkably shifted from original positions under the calculation, for example, the structure of the active site a in the protein cannot be maintained correctly.

As a method of solving this problem, ONIOM (our own n-layered integrated molecular orbital+molecular mechanics method) is proposed [4]. According to this method, the whole system is treated as the MM region temporarily to avoid the problem of the potential discontinuity in the boundary area, however, it is pointed that the group of atoms in the QM space are separately calculated as an independent system and therefore no effect of the MM space is reflected to the QM space self-consistently [3].

In the following, References cited in this description are listed.

[1] J. Gao, “Methods and Applications of Combined Quantum Mechanical and Molecular Mechanical Potentials” in “Reviews in Computational Chemistry,” Vol. 7, K. B. Lipkowitz and D. B. Boyd, Editors, VCH Publishers, Inc., New York, 1996

[2] M. J. Field, P. A. Bash and M. Karplus, J. Comp. Chem., Vol. 11, 700 (1990)

[3] D. M. Philipp, R. A. Friesner, J. Comp. Chem., Vol. 20, 1468 (1999)

[4] T. Vreven, K. Morokuma, J. Comp. Chem., Vol. 21,1419 (2000)

[5] Yasushige Yonezawa, Toshikazu Takada, Toshihiro Sakuma, Kazuto Nakata, Haruki Nakamura, Seibutsu Butsuri (Biophysics), Vol. 43, Supplement 1, B198 (Abstracts for 41st annual meeting, The Biophysical Society of Japan) (2003)

[6] Denshi Kozo no Riron Nyumon: Atarashii Ryoshi Kagaku (Modern Quantum Chemistry (first half): Introduction to Advanced Electronic Structure Theory), p 155, University of Tokyo Press, 1987

[7] P. Pulay, “Direct Use of Gradient for investigating Molecular Energy Surfaces,” in “Modern Theoretical Chemistry 4”, H. F. Scharfer, Editor, Plenum Press, New York and London, 1977

[8] J. A. Pople, R. Krishnan, H. B. Schlegel and J. S. Binkley, Int. J. Quant. Chem., Vol. 13, 225 (1979)

### DISCLOSURE OF INVENTION

Problems to be Solved by the Invention

To make the QM/MM method a practical molecular simulation technique for biological molecules or the like, as described above, it is necessary to solve problems, namely, 1) artificial torsions in the wave function due to unpaired electrons and 2) instability in molecule structures due to discontinuous potential.

Empirical potential E(MM) used in the MM method is defined by bond distance E_{bonds}, bond angel E_{angles}, dihedral angle Eₜₒᵣₛᵢₒₙₛ, and non-covalent bond E_{nonbonds} as shown Eq. (1).

$$\begin{matrix}E ( MM ) = {E}_{bonds} + {E}_{angles} + {E}_{torsions} + {E}_{nonbonds} \\ = {E}^{MM} ( 0 ) + {\sum }_{A}^{P} \frac{\partial {E}^{MM}}{\partial {q}_{A}} Δ {q}_{A} + \\ \frac{1}{2} {\sum }_{A}^{P} {\sum }_{B}^{P} \frac{{\partial }^{2} {E}^{MM}}{\partial {q}_{A} \partial {q}_{B}} Δ {q}_{A} Δ {q}_{B} + …\end{matrix} \qquad ( 1 )$$

where E^{MM}(0) represents all MM energy in the state of equilibrium. Therefore, when whole system is described by the empirical potential, no abnormal molecule skeleton appears in the calculation. On the other hand, since the QM space in itself is strictly described by the quantum mechanics method, basically, there is no possibility in that molecule structures in the QM space are abnormal. This discussion suggests that the problem about the instability in molecule structures can be solved when the surface area joining with the MM space inside the QM space can be impregnated with the empirical potential from the MM space without theoretical contradictions. At this time, there is an essential condition for solution in that unpaired electrons generated in atoms at terminals in the QM space can be hidden logically based on the energy expression.

The present inventors have already expected that a localized molecular orbital is positioned at the boundary between the QM region and the MM region, and the localized orbital is taken as a Frozen Orbital in calculation for the QM region, thereby carrying out the smooth and precise connection between the QM region and the MM region [5].

Accordingly, the object of the present invention is to provide a molecular simulation method and device with logical consistency which can impregnate the superficies of the QM space in junction with the MM space with an empirical potential designated by Eq. (1) while hiding unpaired electrons.

Means for Solving the Problem

According to the first aspect of the present invention, a molecular simulation method is a method for dividing a molecule or a part of molecule to be simulated into a QM space and an MM apace and applying an ab initio molecular orbital method to the QM space and a method based on an empirical potential to the MM space to perform molecular simulation. The molecular simulation method includes the steps of retrieving structure data on the molecule or part of molecule to be simulated from a storage unit, and dividing the structure data into the QM space and the MM space; and replacing a part of a total energy expression in the ab initio molecular orbital method concerning the QM space with an empirical potential.

According to the second aspect of the present invention, a molecular simulation method is a method for dividing a molecule or a part of molecule to be simulated into a QM space and an MM apace and applying an ab initio molecular orbital method to the QM space and a method based on an empirical potential to the MM space to perform molecular simulation. The molecular simulation method includes the steps of: retrieving structure data on the molecule or part of molecule to be simulated from a storage unit, dividing the structure data into the QM space and the MM space, and dividing the QM space into a superficial QM region, which is a region adjacent to the MM space, and a QM region, which is a region except the superficial QM region; acquiring a total energy expression in the ab initio molecular orbital method concerning the superficial QM region; acquiring a total energy expression in the ab initio molecular orbital method concerning the QM region; replacing a part of the total energy expression concerning the superficial QM region with a term based on the empirical potential; and obtaining total energy in the ab initio molecular orbital method concerning the QM space.

According to the third aspect of the present invention, a molecular simulation device is a device for dividing a molecule or a part of molecule to be simulated into a QM space and an MM space and applying an ab initio molecular orbital method to the QM space and a method based on an empirical potential to the MM space to perform molecular simulation. The molecular simulation device includes: a storage unit for storing structure data on the molecule or part of molecule to be simulated; a region division unit for retrieving structure data on the molecule or part of molecule to be simulated from the storage unit, for dividing the structure data into the QM space and the MM space, and for dividing the QM space into a superficial QM region, which is a region adjacent to the MM space, and an QM region, which is a region except the superficial QM region; and a first computing unit for acquiring a total energy expression in the ab initio molecular orbital method concerning the superficial QM region, for acquiring a total energy expression in the ab initio molecular orbital method concerning the QM region, for replacing a part of the total energy expression. concerning the superficial QM region with a term based on the empirical potential, and for obtaining total energy in the ab initio molecular orbital method concerning the QM space.

According to the present invention, in the molecular simulation by the QM/MM method, a part connecting to the MM space in the space to which the QM method is applied is regarded as a superficial QM region, and the superficial QM region is impregnated with the empirical potential. With the technique of the present invention, during the simulation calculation, the structure in the vicinity of active site in protein, namely, the structure of protein in the area in which the QM space and the MM space are connected is maintained correctly. As described above, according to the present invention, the problem of inconsistency caused by division into the QM space and the MM space can be avoided, and more precise molecular simulation can be performed.

### BRIEF DESCRIPTION OF THE DRAWINGS

FIG. 1 is a conceptual view showing QM-MM space division in a protein-ligand complex.

FIG. 2 is a view for explaining one example of division into the QM space and the MM space.

FIG. 3 is a block diagram showing a configuration of a molecular simulation device according to an embodiment of the present invention.

FIG. 4 is an enlarged view of molecule arrangement at a junction portion between the QM space and the MM space.

FIG. 5 is a flow chart showing a procedure of the molecular simulation.

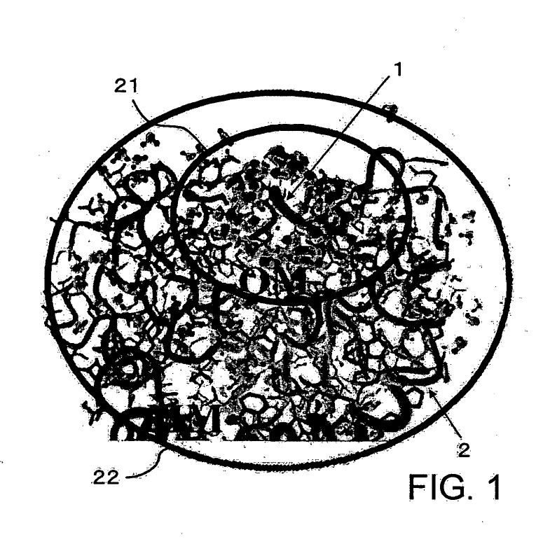

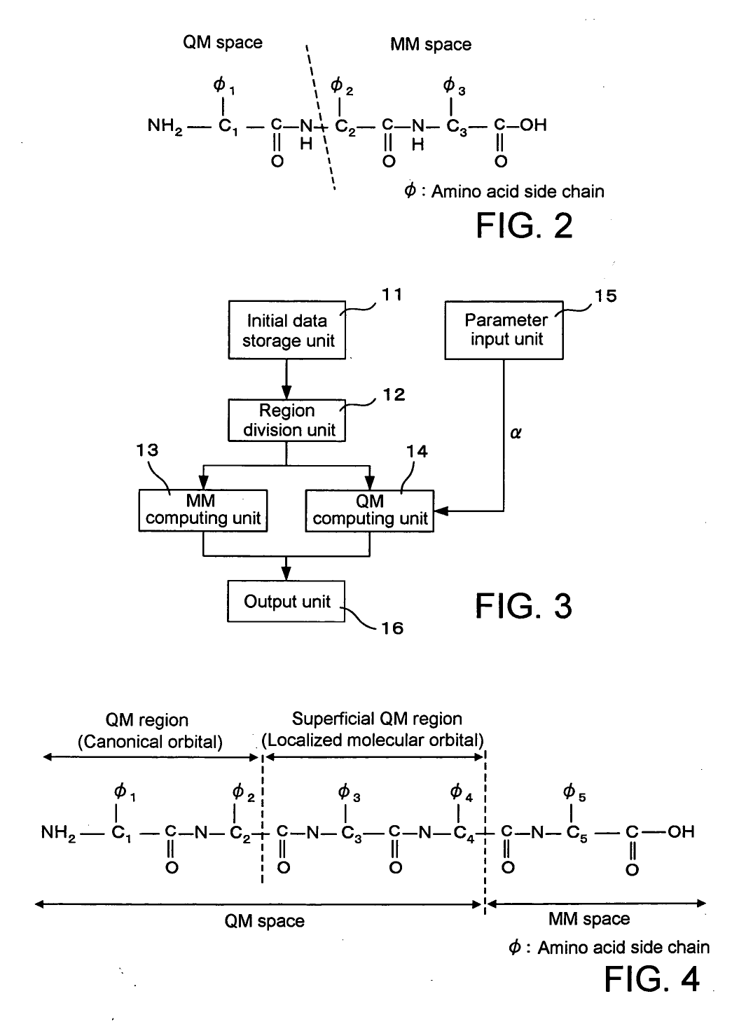

### BEST MODE FOR CARRYING OUT THE INVENTION

In the method according to the present invention, when the molecular simulation is performed by the QM/MM method, in a part of the space to which the QM method is applied, a part of the total energy expression in the ab initio molecular orbital method is replaced with an empirical potential, thereby avoiding the instability in molecule structures generating in the QM-MM boundary area in the conventional QM/MM method. Specifically, on the precondition that the QM/MM method is applied, a molecule to be simulated is divided into the QM space to which the QM method is applied and the MM space to which the MM method is applied, and a part close to the MM space in the QM space is regarded as a superficial QM region. In the superficial QM region, a part of the total energy thereof is replaced with the empirical potential. Preferably, an extent of energy to be replaced with the empirical potential is adjustable by parameters input from the outside. Further, preferably, in the superficial QM region, the wave function of the molecule or the part of molecule to be a part of the superficial QM region is represented by localized molecular orbital. In this way, according to the embodiment, the empirical potential is introduced into the part of the QM space.

First, the logical phase of the method according to the present embodiment is explained in detail.

Now, consideration is given to a localized molecular orbital locally positioning in the molecule or the part of molecule distributed in a superficial region in which the QM space and the MM space are jointed. On the other hand, it is assumed that molecular orbital describing electrons belonging to atoms in the QM space out of the superficial region are given by canonical orbital dispersing in all of the space. Total energy E (QM+PQM) of Hartree-Fock method using these orbitals is given by Eq. (2).

$$E ( QM + PQM ) = {\sum }_{i}^{Q} 2 {H}_{i}^{Q} + {{\sum }_{i}}^{Q} {{\sum }_{j}}^{Q} ( 2 {J}_{ij} - {K}_{ij} ) + {{\sum }_{A > B}}^{Q} \frac{{Z}_{A} {Z}_{B}}{{R}_{AB}} + {{\sum }_{i}}^{Q} {{\sum }_{j}}^{P} ( 2 {J}_{ij} - {K}_{ij} ) + {{\sum }_{i}}^{Q} {{\sum }_{j}}^{Q} ( 2 {J}_{ij} - {K}_{ij} ) + {{{{\sum }^{Q}}_{A} {{\sum }_{B}}^{P}}_{}}^{} \frac{{Z}_{A} {Z}_{B}}{{R}_{AB}} + {{\sum }_{i}}^{P} 2 {H}_{i}^{P} + {{\sum }_{i}}^{P} {{\sum }_{j}}^{P} ( 2 {J}_{ij} - {K}_{ij} ) + {{\sum }_{A > B}}^{P} \frac{{Z}_{A} {Z}_{B}}{{R}_{AB}} \\ where \\ {H}_{i} = \int {φ}_{i} ( - \frac{1}{2} Δ - {{\sum }_{A}}^{Nuclei} \frac{{Z}_{A}}{{r}_{A}} ) {φ}_{i} ⅆ τ \\ {J}_{ij} = \int \int {φ}_{i} ( 1 ) {φ}_{i} ( 1 ) \frac{1}{{r}_{12}} {φ}_{j} ( 2 ) {φ}_{j} ( 2 ) ⅆ {τ}_{1} ⅆ {τ}_{2} \\ {K}_{ij} = \int \int {φ}_{i} ( 1 ) {φ}_{j} ( 1 ) \frac{1}{{r}_{12}} {φ}_{j} ( 2 ) {φ}_{i} ( 2 ) ⅆ {τ}_{1} ⅆ {τ}_{2} \qquad ( 2 )$$

where Q represents a space of canonical orbital and P represents a space of localized molecular orbital. As is clear from explanations which will be described later, the space represented by Q is a region (QM region) purely processed by the QM method without introducing the empirical potential, and the space represented by P is a region (superficial QM region) in which calculation according to the QM method is performed while the empirical potential is introduced. Additionally, Eq. (2) is represented by the usual notation in the field of the molecular orbital method, and therefore φᵢ represents molecular orbital and is represented by

$${φ}_{i} = {\sum }_{r} {C}_{{r}_{i}} {χ}_{r}$$

R_{AB} represents a distance between nuclei A and B, and Z_{A} and Z_{B} represent electric charges of nuclei A and B, respectively. Extension to the post Hartree-Fock method such as multi-arrangement self-consistent field method and interarrangement interaction method, instead of the Hartree-Fock method, is possible with the similar treatment while the localized molecular orbital is regarded as so-called “Frozen Core Orbital.” It is understood that first three terms of Eq. (2) relate to only nuclei and electrons belonging to the QM region, middle three terms relate to interaction between the QM region and the superficial QM region, last three terms of Eq. (2) relate to only nuclei and electrons belonging to the superficial QM region. Therefore, attentions are given to the terms related to only the superficial QM region, namely, the last three terms of Eq. (2), and these terms are divided by parameter α like equation (3). In Eq. (3), 0 ≦α≦1.

$$E ( QM + PQM ) = {\sum }_{i}^{Q} 2 {H}_{i}^{Q} + {{\sum }_{i}}^{Q} {{\sum }_{j}}^{Q} ( 2 {J}_{ij} - {K}_{ij} ) + {{\sum }_{A > B}}^{Q} \frac{{Z}_{A} {Z}_{B}}{{R}_{AB}} + {{\sum }_{i}}^{Q} {{\sum }_{j}}^{P} ( 2 {J}_{ij} - {K}_{ij} ) + {{\sum }_{A}}^{P} {{\sum }_{B}}^{Q} ( 2 {J}_{ij} - {K}_{ij} ) + {{{{\sum }^{Q}}_{A} {{\sum }_{B}}^{P}}_{}}^{} \frac{{Z}_{A} {Z}_{B}}{{R}_{AB}} + ( 1 - α ) [ {{\sum }_{i}}^{P} 2 {H}_{i}^{P} + {{\sum }_{i}}^{P} {{\sum }_{j}}^{P} ( 2 {J}_{ij} - {K}_{ij} ) + {{\sum }_{A > B}}^{P} \frac{{Z}_{A} {Z}_{B}}{{R}_{AB}} ] + α [ {{\sum }_{i}}^{P} 2 {H}_{i}^{P} + {{\sum }_{i}}^{P} {{\sum }_{j}}^{P} ( 2 {J}_{ij} - {K}_{ij} ) + {{\sum }_{A > B}}^{P} \frac{{Z}_{A} {Z}_{B}}{{R}_{AB}} ] \qquad ( 3 )$$

In Eq. (3), since only the terms are divided formally by α and (α−1), the value of the total energy is equal to that of Eq. (2). Then, the last term of Eq. (3), namely, the term multiplied by α is series expanded (Taylor expanded) in the vicinity of the equilibrium structure concerning minute change Δq of the coordinate of the nucleus, and thus the term is represented by Eq. (4).

$$E ( QM + PQM ) = {\sum }_{i}^{Q} 2 {H}_{i}^{Q} + {{\sum }_{i}}^{Q} {{\sum }_{j}}^{Q} ( 2 {J}_{ij} - {K}_{ij} ) + {{\sum }_{A > B}}^{Q} \frac{{Z}_{A} {Z}_{B}}{{R}_{AB}} + {{\sum }_{i}}^{Q} {{\sum }_{j}}^{P} ( 2 {J}_{ij} - {K}_{ij} ) + {{\sum }_{A}}^{P} {{\sum }_{B}}^{Q} ( 2 {J}_{ij} - {K}_{ij} ) + {{{{\sum }^{Q}}_{A} {{\sum }_{B}}^{P}}_{}}^{} \frac{{Z}_{A} {Z}_{B}}{{R}_{AB}} + ( 1 - α ) [ {{\sum }_{i}}^{P} 2 {H}_{i}^{P} + {{\sum }_{i}}^{P} {{\sum }_{j}}^{P} ( 2 {J}_{ij} - {K}_{ij} ) + {{\sum }_{A > B}}^{P} \frac{{Z}_{A} {Z}_{B}}{{R}_{AB}} ] + α [ E ( 0 ) + {\sum }_{A}^{P} \frac{\partial E}{\partial {q}_{A}} Δ {q}_{A} + \frac{1}{2} {{\sum }_{A}}^{P} {{\sum }_{B}}^{P} Δ {q}_{A} Δ {q}_{B} + … ] \qquad ( 4 )$$

If all atoms belonging to the QM space are in the positions of stable structures, namely, in the equilibrium point, expansion term is set to be infinite, and thus Eq. (3) and Eq. (4) give total energy equally again.

Here, in order to incorporate an energy expression by the empirical potential into the superficial region in the QM space, the last term of Eq. (4) is replaced with the term of the empirical potential, and then total energy expression is changed like Eq. (5).

$$E ( QM + PQM ) = {\sum }_{i}^{Q} 2 {H}_{i}^{Q} + {{\sum }_{i}}^{Q} {{\sum }_{j}}^{Q} ( 2 {J}_{ij} - {K}_{ij} ) + {{\sum }_{A > B}}^{Q} \frac{{Z}_{A} {Z}_{B}}{{R}_{AB}} + {{\sum }_{i}}^{Q} {{\sum }_{j}}^{P} ( 2 {J}_{ij} - {K}_{ij} ) + {{\sum }_{A}}^{P} {{\sum }_{B}}^{Q} ( 2 {J}_{ij} - {K}_{ij} ) + {{{{\sum }^{Q}}_{A} {{\sum }_{B}}^{P}}_{}}^{} \frac{{Z}_{A} {Z}_{B}}{{R}_{AB}} + ( 1 - α ) [ {{\sum }_{i}}^{P} 2 {H}_{i}^{P} + {{\sum }_{i}}^{P} {{\sum }_{j}}^{P} ( 2 {J}_{ij} - {K}_{ij} ) + {{\sum }_{A > B}}^{P} \frac{{Z}_{A} {Z}_{B}}{{R}_{AB}} ] + α [ {E}^{MM} ( 0 ) + {\sum }_{A}^{P} \frac{1}{2} {k}_{i}^{r} Δ {r}^{2} + {\sum }_{i} \frac{1}{2} {k}_{i}^{Θ} {ΔΘ}_{i}^{2} + {\sum }_{i} \frac{1}{2} {k}_{i}^{ψ} Δ {Ψ}_{i}^{2} ] \qquad ( 5 )$$

Interactions of atoms belonging to the MM space with only atoms in the superficial QM region are described in accordance with the usual procedure by bond distance r, bond angle Θ, and dihedral angle Ψ so as to be continued with the potential in the MM space smoothly just enough. Since the last term of Eq. (5) is the term of the empirical potential, parameter α represents how terms of the QM method and terms of the MM method are combined, namely, how much the superficial QM region is impregnated with the empirical potential. A suitable value of parameter α may be changed in accordance with a molecule system or a purpose of molecular simulation, and may be set to, for example, about 0.2.

In this way, total energy E (Total) in which the QM space and the MM space are added is represented by Eq. (6).
E(Total)=E(QM+PQM)+E(MM)+E(QM+PQM: MM) (6)

Needless to say, E(MM) represents the energy obtained by applying the empirical potential to the MM space by the molecule mechanics method or the like. An expression for representing interactions between atoms in the QM space and atoms in the MM space varies in accordance with physical and chemical properties to which attentions are given, however, in this embodiment, the expression typically represents electrostatic effects generated by the atoms in the MM space against the atoms in the QM space and dipole efficiencies induced in the atoms of the MM space by the change in electron distribution in the QM space.

In the above explanations, only one superficial QM region is set, however, the above discussion may be extended to a case where a plurality of superficial QM regions is set in one molecule. In this case, terms of Coulomb forces and terms of van der Waals forces among the superficial QM regions have to be considered. Therefore, Eq. (2) is extended to a case where a plurality of superficial QM regions are set. In this case, since first three terms of Eq. (2) relate to only nuclei and electrons belonging to the QM region, these are unnecessary to be changed. Since middle three terms of Eq. (2) relate to interaction between the QM region and the superficial QM region, the terms may be obtained for the respective superficial QM regions independently and may be added. The last three terms of Eq. (2) may be modified as Eq. (7) in accordance with the similar procedure to the above-described procedure.

$$\begin{matrix}\begin{matrix}{{\sum }_{i}}^{P} 2 {H}_{i}^{P} + \\ {{\sum }_{i}}^{P} {{{{\sum }_{j}}^{P} ( 2 {J}_{ij} - {K}_{ij} ) + {{\sum }_{A > B}}^{P} \frac{{Z}_{A} {Z}_{B}}{{R}_{AB}}}_{}}^{}\end{matrix} = {{\sum }_{i}}^{P} \{ 2 {H}_{i}^{P} + {{\sum }_{j}}^{P} ( 2 {J}_{ij} - {K}_{ij} ) \} {{\sum }_{A > B}}^{P} \frac{{Z}_{A} {Z}_{B}}{{R}_{AB}} \\ = {\sum }_{m = 1}^{PQM} {\sum }_{i = 1}^{P ∈ m} \{ 2 {H}_{i}^{P} + {{\sum }_{j}}^{P} ( 2 {J}_{ij} - {K}_{ij} ) \} + \\ {\sum }_{m = 1}^{PQM} {\sum }_{A = 1}^{A ∈ m} {\sum }_{B ( \neq A )}^{P} \frac{1}{2} \frac{{Z}_{A} {Z}_{B}}{{R}_{AB}} \\ = {\sum }_{m = 1}^{PQM} [ {\sum }_{i = 1}^{P ∈ m} \{ 2 {H}_{i}^{P} + {{\sum }_{j}}^{P} ( 2 {J}_{ij} - {K}_{ij} ) \} + \\ {\sum }_{A = 1}^{A ∈ m} {\sum }_{B ( \neq A )}^{P} \frac{1}{2} \frac{{Z}_{A} {Z}_{B}}{{R}_{AB}} ] \\ = {\sum }_{m = 1}^{PQM} ( 1 - {α}_{m} ) [ {\sum }_{i = 1}^{P ∈ m} \{ 2 {H}_{i}^{P} + {{\sum }_{j}}^{P} ( 2 {J}_{ij} - {K}_{ij} ) \} + \\ {\sum }_{A = 1}^{A ∈ m} {\sum }_{B ( \neq A )}^{P} \frac{1}{2} \frac{{Z}_{A} {Z}_{B}}{{R}_{AB}} ] + \\ α [ {\sum }_{i = 1}^{P ∈ m} \{ 2 {H}_{i}^{P} + {{\sum }_{j}}^{P} ( 2 {J}_{ij} - {K}_{ij} ) \} + {\sum }_{A = 1}^{A ∈ m} {\sum }_{B ( \neq A )}^{P} \frac{1}{2} \frac{{Z}_{A} {Z}_{B}}{{R}_{AB}} ] \\ = {\sum }_{m = 1}^{PQM} ( 1 - {α}_{m} ) [ {\sum }_{i = 1}^{P ∈ m} \{ 2 {H}_{i}^{P} + {{\sum }_{j}}^{P} ( 2 {J}_{ij} - {K}_{ij} ) \} + \\ {\sum }_{A = 1}^{A ∈ m} {\sum }_{B ( \neq A )}^{P} \frac{1}{2} \frac{{Z}_{A} {Z}_{B}}{{R}_{AB}} ] + {\sum }_{j = 1}^{PQM} {α}_{m} [ {E}_{0}^{m} + {E}^{m} ]\end{matrix} \qquad ( 7 )$$

Here, it is assumed that PQM pieces of superficial QM regions exist, and parameter αₘ representing how terms of the QM method and terms of the MM method are combined is set for each superficial QM region. E₀^{m} in Eq. (7) corresponds to E^{MM}(0) in Eq. (5), and represents total MM energy in the equilibrium condition in m-th superficial QM region. E^{m} is represented by Eq. (8).

$${E}^{m} = {\sum }_{i} \frac{1}{2} {k}_{i}^{r} Δ {r}^{2} + \frac{1}{2} {k}_{i}^{Θ} {ΔΘ}_{i}^{2} + {\sum }_{i} \frac{1}{2} {k}_{i}^{ψ} Δ {Ψ}_{i}^{2} + {\sum }_{i} {\sum }_{j} 4 {ɛ}_{ij} [ {( \frac{{σ}_{ij}}{{r}_{ij}} )}^{12} - {( \frac{{σ}_{ij}}{{r}_{ij}} )}^{6} ] + {\sum }_{i \neq j} \frac{{q}_{i} {q}_{j}}{ɛ {r}_{ij}} \qquad ( 8 )$$

Equation (8) is an equation based on the empirical potential including Coulomb interaction and van der Waals interaction, the first term represents contribution by bond distance r, the second term represents contribution by bond angle Θ, the third term represents contribution by dihedral angle Ψ, the forth term represents van der Waals forces among the superficial QM regions, and the last term represents Coulomb forces among the superficial QM regions. In this way, with the exception that the terms of Coulomb forces and van der Waals forces have to be considered, though there is a plurality of superficial QM regions, the same treatment can be performed as only one superficial QM region exists.

Next, a terminal atom in the superficial QM region is described. Since the atom at the terminal has a problem of unpaired electrons as it is cut, the link atom method in which an existing atom at the other end for forming the covalent bonds is regarded as a hydrogen-similar atom. At this time, only atomic orbital of valence electrons are used as a basis function, and it is necessary to adjust orbital exponent previously so that Mulliken charges by all-electron calculation are be reproduced.

Next, concrete explanations are given of the molecular simulation method and device according to the embodiment based on the above-described theory. FIG. 3 is a block diagram showing a configuration of a molecular simulation device according to the embodiment of the present invention.

The molecular simulation device uses, as structure data of a molecule to be simulated, coordinate data or the like of respective atoms forming the molecule. The molecular simulation device is provided with initial data storage unit 11 for being stored with structure data of molecules to be simulated and the like, region division unit 12 for dividing the structure data stored in initial data storage unit 11 into the QM space and the MM space and further dividing the QM space into a superficial QM region to be a connection part with the MM space and the other QM region, MM computing unit 13 for executing a molecular simulation calculation based on the MM method such as molecule mechanics for the MM space, QM computing unit 14 for executing a molecular simulation calculation based on the ab initio molecular orbital method for the QM space, parameter input unit 15 for inputting above-described parameter α (0≦α≦1), and output unit 16 for outputting the calculated results in MM computing unit 13 and QM computing unit 14 totally. QM computing unit 14 calculates all energy E(QM+PQM) by the QM method as indicated by above-described Eq. (5). In other words, QM computing unit 14, for the superficial QM region, uses the localized molecular orbital and overlays energy components by the QM method with the empirical potential components at a ratio designated by parameter α to execute the calculation. Also, for the QM region, QM computing unit 14 executes the calculation by using the canonical orbital (expanded molecular orbital) similarly to the usual QM method. Additionally, MM computing unit 13 mainly executes calculations of the empirical potential, and QM computing unit 14 mainly executes calculations of the two-electron integration. Therefore, optimal hardware configurations are respectively different. The molecular simulation device according to the present embodiment is suitable for being configured in a computer cluster, however, in such a case, MM computing unit 13 and QM computing unit 14 are preferably configured by respective hardware configurations of computers.

FIG. 4 shows one example of division into the QM space (QM region+superficial QM region) and the MM space. The boundary between the QM region and the superficial QM region is set to the position of C—C bond in the second amino acid residues from the left in FIG. 4. The boundary between the superficial QM region and the MM space is set to the position of C—C bond in the fourth amino acid residues from the left in FIG. 4. These boundaries are suitably set in accordance with a molecule to be simulated and a propose of simulation, however, in order to improve the accuracy of the calculation, a boundary is preferably set to the position of single bond (σ bond).

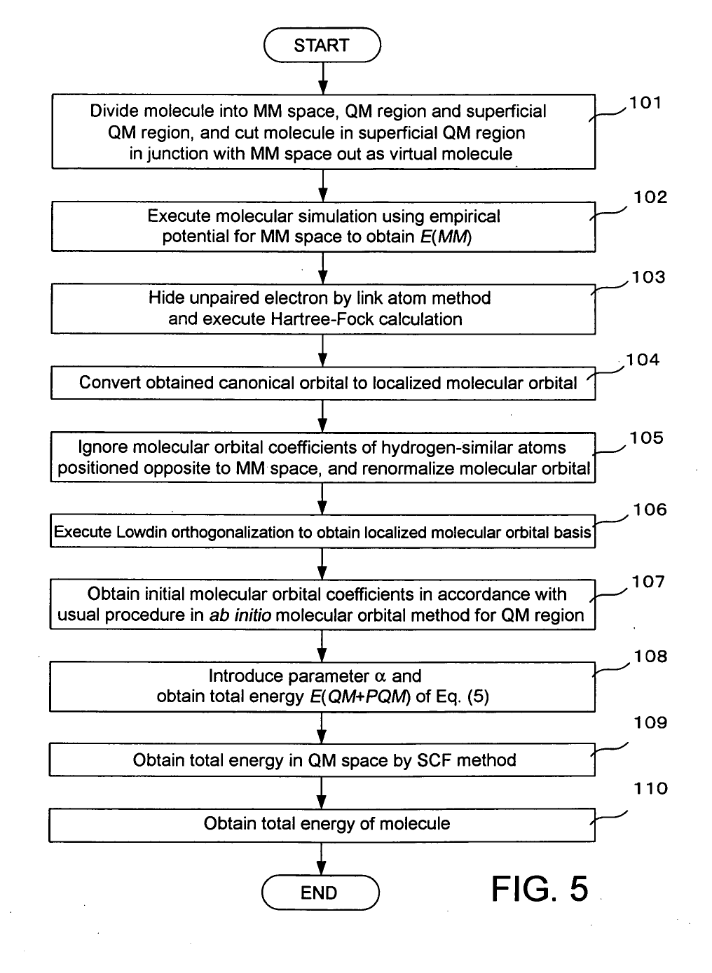

Next, the actual calculation procedure according to the present embodiment is explained based on the above-described theoretical phase with reference to the flow chart in FIG. 5.

First, in Step 101, initial data storage unit 11 reads structure data (coordinate data) of a molecule to be simulated from initial data storage unit 11, divides the molecule into the QM space and the MM space, divides the QM space into the QM region and the superficial QM region, and cut the molecule or the part of molecule in superficial QM region in junction with the MM space out as a virtual molecule. The structure data concerning the MM space is transmitted to MM computing unit 13. In Step 102, MM computing unit 13 executes the molecular simulation based on the empirical potential method such as molecular mechanics for the MM space. The structure data of the QM space (QM region and superficial QM region) is transmitted to QM computing unit 14. Also, when the MM calculation is performed, coordinate data of atoms adjacent to the MM space in the superficial QM region is necessary, and therefore this coordinate data is also transmitted to MM computing unit 13. Similarly, coordinate data of atoms adjacent to the superficial QM region in the MM space is transmitted to QM computing unit 14.

When the structure data is transmitted, in Step 103, QM computing unit 14 starts the QM calculation, specifically, Hartree-Fock calculation. With the above-described division of molecule into the QM region, superficial QM region, and MM space, the covalent bonds are cut in the molecule or the part of molecule. As a result, unpaired electrons generate at both ends or one end of the molecule or the part of molecule. QM computing unit 14 cancels the unpaired electrons by the above-described link atom method by introducing hydrogen-similar atoms, and executes the Hartree-Fock calculation for the superficial QM region.

As a result of Step 103, the canonical orbital is obtained. Then, in step 104, the canonical orbital is converted into localized molecular orbital. In Step 105, molecular orbital coefficients of hydrogen-similar atoms positioned opposite to the MM space are ignored to renormalize the molecular orbital. After that, QM computing unit 14, in Step 106, arbitrarily selects a plurality of molecular orbital localized to the MM space among the localized molecular orbital in the superficial QM region and executes Lowdin orthogonalization [6] to obtain a localized molecular orbital basis which is normalized and orthogonalized. As reasons that the orthogonalization is executed in Step 106, orthogonality is not assured under influences of introduction of hydrogen-similar atoms (link atoms) or the like.

Concerning the electrons out of those processed in Steps 103 to 106 among the electrons in the QM space, namely, the electrons in the QM region, QM computing unit 14, in Step 107, obtains initial molecular orbital coefficients in accordance with the usual procedure in the ab initio molecular orbital method. QM computing unit 14 uses the molecular orbital obtained in Step 106 and Step 107, makes an antisymmetric wave function, and obtains total energy E(QM+PQM) of above-described Eq. (5). In this case, parameter α included in Eq. (5) is necessary, is input through parameter input unit 15 from the outside, and is given from parameter input unit 15 to QM computing unit 14. After that, QM computing unit 14, in Step 109, optimizes molecular orbital coefficients other than the localized molecular orbital by the Self-consistent Field (SCF) method based on variational method and obtains total energy in the QM space.

With the above-described processes, since the total energy in the MM space and the total energy in the QM space can be obtained, output unit 16 combines, in Step 110, both of the total energies based on Eq. (6) and outputs energy E(Total) of the whole molecule to be simulated.

Forces acting on nuclei necessary to obtain stable structures of molecules or chemical reaction trajectory can be obtained by differentiating Eq. (6) with respect to coordinates of nuclei. At this time, a partial differential term for the molecular orbital coefficient appears, however, the partial differential term for the canonical orbital is replaced with a partial differential term of overlapping integral by the energy gradient method [7]. It is necessary to calculate the partial differential term for the localized molecular orbital coefficients, however, it can be calculated strictly using CPHF (Coupled Perturbed Hartree-Fock) method [8]. Successively, localized molecular orbital concerning a molecule or a part of molecule in the superficial QM region is newly obtained using the updated coordinate of a nucleus. At this time, overlaps with previous localized molecular orbital are obtained and orbital with the largest overlap is selected, thereby automatically obtaining the closest orbital to the localized molecular orbital which is previously selected. The calculation of localized molecular orbital, the determination of the total energy and molecular orbital coefficients by the Hartree-Fock method, and the calculation of updated coordinate of nucleus based on the forces acting on the nucleus are repeated, thereby calculating the stable structure and the chemical reaction trajectory.

The above-described molecular simulation device is typically carried out by a computer cluster, and the computer cluster is provided with a control computer functioning as initial data storage unit 11, region division unit, parameter input unit 15, and output unit 16, a computer or a group of computers functioning as MM computing unit 13, and a computer or a group of computers functioning as QM computing unit 14.

These computers read programs for executing functions to be served by the respective computers and function as the control computer, the computer for the MM calculation, and the computer for the QM calculation. Such the programs are read into the computers via a storage medium such as magnetic tape or CD-ROM or via a network.

When a relatively small molecule is simulated, the above-described molecular simulation can be executed using a single computer. In this case, a computer program for executing the molecular simulation based on the above-described procedure may be read into a computer such as a supercomputer or a personal computer, and the program may be executed. The program for executing the molecular simulation is read into the computer via a storage medium such as a magnetic tape or CD-ROM or via a network.

The above-described program, the storage media stored with such the program, a program product including such the program is also included in the scope of the present invention.

### INDUSTRIAL APPLICABILITY

Proteins carry out various functions in living bodies, however, when proteins are interpreted in view of enzymes, they are important chemical substances related to general chemical industries. Therefore, according to the present invention, interactions between proteins and substrates can be simulated with a high degree of reliability based on the quantum mechanics method, and the simulation provides research methods effective in industries over wide fields such as production of drugs and functional foods, chemical industrial fields, and development of eco-friendly substances.

1. A molecular simulation method for dividing a molecule or a part of molecule to be simulated into a QM space and an MM apace and applying an ab initio molecular orbital method to the QM space and a method based on an empirical potential to the MM space to perform molecular simulation, the method comprising the steps of:
retrieving structure data on the molecule or part of molecule to be simulated from a storage unit, and dividing the structure data into the QM space and the MM space; and
replacing a part of a total energy expression in the ab initio molecular orbital method concerning the QM space with an empirical potential.

2. A molecular simulation method for dividing a molecule or a part of molecule to be simulated into a QM space and an MM apace and applying an ab initio molecular orbital method to the QM space and a method based on an empirical potential to the MM space to perform molecular simulation, the method comprising the steps of:
retrieving structure data on the molecule or part of molecule to be simulated from a storage unit, dividing the structure data into the QM space and the MM space, and dividing the QM space into a superficial QM region, which is a region adjacent to the MM space, and a QM region, which is a region except the superficial QM region;
acquiring a total energy expression in the ab initio molecular orbital method concerning the superficial QM region;
acquiring a total energy expression in the ab initio molecular orbital method concerning the QM region;
replacing a part of the total energy expression concerning the superficial QM region with a term based on the empirical potential; and
obtaining total energy in the ab initio molecular orbital method concerning the QM space.

3. The method according to claim 2, further comprising the step of inputting a parameter, wherein a ratio of replacing the part of the total energy expression in the superficial QM region with the term based on the empirical potential is designated by the parameter.

4. The method according to claim 3, wherein a plurality of superficial QM regions are set, a parameter is input for each of the superficial QM regions, and an empirical potential including Coulomb interactions and van der Waals interactions among the superficial QM regions is used.

5. The method as according to claim 2, further comprising the step of representing a wave function in the superficial QM region by a localized molecular orbital.

6. The method according to claim 5, further comprising the step of performing a molecule structure optimization and a time evolution calculation, wherein the localized molecular orbital is updated when the molecule structure optimization and the time expansion calculation are performed.

7. A molecular simulation device for dividing a molecule or a part of molecule to be simulated into a QM space and an MM space and applying an ab initio molecular orbital method to the QM space and a method based on an empirical potential to the MM space to perform molecular simulation, the device comprising:
a storage unit for storing structure data on the molecule or part of molecule to be simulated;
a region division unit for retrieving structure data on the molecule or part of molecule to be simulated from the storage unit, for dividing the structure data into the QM space and the MM space, and for dividing the QM space into a superficial QM region, which is a region adjacent to the MM space, and an QM region, which is a region except the superficial QM region; and
a first computing unit for acquiring a total energy expression in the ab initio molecular orbital method concerning the superficial QM region, for acquiring a total energy expression in the ab initio molecular orbital method concerning the QM region, for replacing a part of the total energy expression concerning the superficial QM region with a term based on the empirical potential, and for obtaining total energy in the ab initio molecular orbital method concerning the QM space.

8. The device according to claim 7, further comprising a parameter input unit for inputting a parameter, wherein the first computing unit replaces the part of the total energy expression in the superficial QM region with the term based on the empirical potential at a ratio designated by the parameter.

9. The device according to claim 8, wherein a plurality of superficial QM regions are set, a parameter is input for each of the superficial QM reagions, and an empirical potential including Coulomb interactions and van der Waals interactions among the superficial QM regions is used.

10. The device according to claim 7, further comprising:
a second computing unit for obtaining total energy based on the empirical potential concerning the MM space; and
an output unit for calculating total energy of the molecule or part of molecule to be simulated in accordance with the total energy obtained in the first computing unit and the total energy obtained in the second computing unit.

11. A program making a computer function as
a storage unit for storing structure data on a molecule or part of molecule to be simulated;
a region division unit for retrieving structure data on the molecule or part of molecule to be simulated from the storage unit, for dividing the structure data into a QM space and an MM space, and for dividing the QM space into a superficial QM region, which is a region adjacent to the MM space, and an QM region, which is a region except the superficial QM region; and
a first computing unit for acquiring a total energy expression in an ab initio molecular orbital method concerning the superficial QM region, for acquiring a total energy expression in the ab initio molecular orbital method concerning the QM region, for replacing a part of the total energy expression concerning the superficial QM region with a term based on the empirical potential, and for obtaining total energy in the ab initio molecular orbital method concerning the QM space.

12. The program according to claim 11, further making the computer function as:
a second computing unit for obtaining total energy based on the empirical potential concerning the MM space; and
an output unit for calculating total energy of the molecule or part of molecule to be simulated in accordance with the total energy obtained in the first computing unit and the total energy obtained in the second computing unit.

13. A storage medium readable by a computer in which the program according to claim 11 is stored.

14. The method as according to claim 3, further comprising the step of representing a wave function in the superficial QM region by a localized molecular orbital.

15. The method as according to claim 4, further comprising the step of representing a wave function in the superficial QM region by a localized molecular orbital.

16. The device according to claim 8, further comprising:
a second computing unit for obtaining total energy based on the empirical potential concerning the MM space; and
an output unit for calculating total energy of the molecule or part of molecule to be simulated in accordance with the total energy obtained in the first computing unit and the total energy obtained in the second computing unit.

17. The device according to claim 9, further comprising:
a second computing unit for obtaining total energy based on the empirical potential concerning the MM space; and
an output unit for calculating total energy of the molecule or part of molecule to be simulated in accordance with the total energy obtained in the first computing unit and the total energy obtained in the second computing unit.

18. A storage medium readable by a computer in which the program according to claim 12 is stored
